(19) United States
(12) Patent Application Publication
(10) Pub. No.: US 2026/0338684 A1
(43) Pub. Date: Oct. 29, 2026

(54) FREQUENCY SELECTIVE TERAHERTZ SPECTROSCOPY

(71) Applicant: ECOLE DE TECHNOLOGIE SUPERIEURE, Montréal (CA)

(72) Inventor: François BLANCHARD, Montréal (CA)

(21) Appl. No.: 19/107,858

(22) PCT Filed: Sep. 5, 2023
(86) PCT No.: PCT/CA2023/051162

§ 371 Date: Feb. 28, 2025

Related U.S. Application Data
(60) Provisional application No. 63/403,435, filed on Sep. 2, 2022.
(60) Provisional application No. 63/457,932, filed on Apr. 7, 2023.

(51) Int. Cl. G01N 21/3586

(52) U.S. Cl. CPC G01N 21/3586

(57) ABSTRACT

A system for performing frequency selective terahertz spectroscopy of a sample comprises a terahertz radiation emitter configured to emit incident broadband terahertz radiation towards the sample, a terahertz radiation filter configured to receive outgoing broadband terahertz radiation emitted from the sample and indicative of a frequency content of the incident broadband terahertz radiation passing through the sample, and to filter frequency components of the outgoing broadband terahertz radiation for generating filtered narrowband terahertz radiation, at least one terahertz radiation receiver optically coupled to the terahertz radiation filter and configured to generate at least one electrical signal based on the filtered narrowband terahertz radiation, and a computing unit communicatively coupled to the at least one terahertz radiation receiver and configured to perform spectroscopy of the sample based on a ratio between the at least one electrical signal and a reference signal.

### CROSS-REFERENCE TO RELATED APPLICATIONS

This patent application claims priority on U.S. Patent Application No. 63/403,435, filed on Sep. 2, 2022, and on U.S. Patent Application No. 63/457,932, filed on Apr. 7, 2023, the entire contents of which are incorporated herein by reference.

### FIELD

The present disclosure generally relates to the field of spectroscopy, and more specifically to frequency selective terahertz spectroscopy.

### BACKGROUND

Characterization of properties of matter in the terahertz (THz) frequency range can be performed using terahertz spectroscopy. Terahertz spectroscopy can be classified in two approaches, producing substantially different data sets: terahertz time-domain pulse measurements produced by terahertz time-domain spectroscopy (THz-TDS) and continuous terahertz wave (CW) data. While CW has the advantage of being highly frequency resolved, obtaining multispectral information from a sample is time consuming.

Conventional THz-TDS techniques (so-called “pump-probe” approaches) comprise, at the transmitter side, a terahertz emitter that converts a short laser pulse into terahertz radiation. On the receiver side, the terahertz radiation is sampled with a time-shifted copy of the laser pulse. This technique usually involves a time delay, which is either realized with a mechanical stage or by synchronizing the pulse trains of two lasers. However, the time delay remains the bottleneck in terms of attainable data rates and existing techniques are simply not fast enough for widespread industrial use.

Thus, there remains room for improvement.

### SUMMARY

In accordance with one aspect, there is provided a system for performing frequency selective terahertz spectroscopy of a sample. The system comprises a terahertz radiation emitter configured to emit incident broadband terahertz radiation towards the sample, a terahertz radiation filter configured to receive outgoing broadband terahertz radiation emitted from the sample, the outgoing broadband terahertz radiation indicative of a frequency content of the incident broadband terahertz radiation passing through the sample, and to filter frequency components of the outgoing broadband terahertz radiation for generating filtered narrowband terahertz radiation, at least one terahertz radiation receiver optically coupled to the terahertz radiation filter, the at least one terahertz radiation receiver configured to receive the filtered narrowband terahertz radiation from the terahertz radiation filter and to generate at least one electrical signal based on the filtered narrowband terahertz radiation, and a computing unit communicatively coupled to the at least one terahertz radiation receiver and configured to receive therefrom the at least one electrical signal, the computing unit configured to perform spectroscopy of the sample based on a ratio between the at least one electrical signal and a reference signal.

In some embodiments, the terahertz radiation filter is configured to filter the frequency components of the outgoing broadband terahertz radiation by reflecting a high frequency component of the outgoing broadband terahertz radiation that is above a cut-off frequency of the terahertz radiation filter, thereby generating high pass terahertz radiation, and absorbing a low frequency component of the outgoing broadband terahertz radiation that is below the cut-off frequency of the terahertz radiation filter, thereby generating low pass terahertz radiation.

In some embodiments, the at least one terahertz radiation receiver comprises a first terahertz radiation receiver and a second terahertz radiation receiver, the first terahertz radiation receiver configured to receive the high pass terahertz radiation from the terahertz radiation filter and to generate a first electrical signal indicative of an electric field amplitude of the high pass terahertz radiation, and the second terahertz radiation receiver configured to receive the low pass terahertz radiation from the terahertz radiation filter and to generate a second electrical signal indicative of the electric field amplitude of the low pass terahertz radiation.

In some embodiments, the computing unit is communicatively coupled to the first terahertz radiation receiver and to the second terahertz radiation receiver, and configured to receive therefrom the first electrical signal and the second electrical signal, the computing unit configured to perform spectroscopy of the sample based on the ratio between the first electrical signal and the second electrical signal.

In some embodiments, the computing unit is configured to compute the ratio by dividing the electric field amplitude of the high pass terahertz radiation as determined from the first electrical signal and the electric field amplitude of the low pass terahertz radiation as determined from the second electrical signal.

In some embodiments, the terahertz radiation filter comprises a rotating disc having a plurality of frequency selective surfaces formed therein, the plurality of frequency selective surfaces configured to successively filter the frequency components of the outgoing broadband terahertz radiation as the disc rotates for generating the filtered narrowband terahertz radiation.

In some embodiments, the at least one terahertz radiation receiver is configured to generate the at least one electrical signal comprising a plurality of filter signals associated with the frequency components of the outgoing broadband terahertz radiation successively filtered by the plurality of frequency selective surfaces, and the computing unit is configured to perform spectroscopy of the sample by computing the ratio between an electric field amplitude of each of the plurality of filter signals and the electric field amplitude of the reference signal.

In some embodiments, the plurality of frequency selective surfaces are configured to filter a high frequency component of the outgoing broadband terahertz radiation that is above a cut-off frequency of the terahertz radiation filter, thereby generating high pass terahertz radiation, and to filter a low frequency component of the outgoing broadband terahertz radiation that is below the cut-off frequency of the terahertz radiation filter, thereby generating low pass terahertz radiation.

In some embodiments, the at least one terahertz radiation receiver is configured to generate a first electrical signal indicative of an electric field amplitude of the high pass terahertz radiation, and a second electrical signal indicative of the electric field amplitude of the low pass terahertz radiation, and the computing unit is configured to perform spectroscopy of the sample based on the ratio between the first electrical signal and the second electrical signal, by computing the ratio between an electric field amplitude of the high pass terahertz radiation as determined from the first electrical signal and the electric field amplitude of the low pass terahertz radiation as determined from the second electrical signal.

In some embodiments, the plurality of frequency selective surfaces comprises a first plurality of frequency selective surfaces oriented in a vertical polarization direction and a second plurality of frequency selective surfaces oriented in a horizontal polarization direction, the at least one terahertz radiation receiver is configured to generate the at least one electrical signal comprising a first electrical signal associated with the frequency components of the outgoing broadband terahertz radiation filtered by each the first plurality of frequency selective surfaces and a second electrical signal associated with the frequency components of the outgoing broadband terahertz radiation filtered by each of the second plurality of frequency selective surfaces, and the computing unit is configured to perform spectroscopy of the sample based on the ratio between the first electrical signal and the second electrical signal.

In some embodiments, the system further comprises a laser source configured to generate a train of laser pulses, the terahertz radiation emitter coupled to the laser source and configured to receive the train of laser pulses therefrom and to convert the train of laser pulses into the incident broadband terahertz radiation.

In some embodiments, the terahertz radiation emitter comprises an emitter antenna for receiving the train of laser pulses and a photoconductive switch for emitting the incident broadband terahertz radiation.

In some embodiments, the at least one terahertz radiation receiver comprises a receiver antenna connected to a Schottky diode, the Schottky diode having a usable frequency range that matches a peak power of the filtered narrowband terahertz radiation.

In accordance with another aspect, there is provided a method for performing frequency selective terahertz spectroscopy of a sample. The method comprises emitting incident broadband terahertz radiation towards the sample, receiving outgoing broadband terahertz radiation emitted from the sample, the outgoing broadband terahertz radiation indicative of a frequency content of the incident broadband terahertz radiation passing through the sample, filtering frequency components of the outgoing broadband terahertz radiation for generating filtered narrowband terahertz radiation, generating at least one electrical signal based on the filtered narrowband terahertz radiation, and performing spectroscopy of the sample based on a ratio between the at least one electrical signal and a reference signal.

In some embodiments, filtering the frequency components of the outgoing broadband terahertz radiation comprises reflecting a high frequency component of the outgoing broadband terahertz radiation that is above a cut-off frequency of the terahertz radiation filter, thereby generating high pass terahertz radiation, and absorbing a low frequency component of the outgoing broadband terahertz radiation that is below the cut-off frequency of the terahertz radiation filter, thereby generating low pass terahertz radiation.

In some embodiments, generating the at least one electrical signal comprises generating a first electrical signal indicative of an electric field amplitude of the high pass terahertz radiation and a second electrical signal indicative of the electric field amplitude of the low pass terahertz radiation, and spectroscopy of the sample is performed based on the ratio by dividing the electric field amplitude of the high pass terahertz radiation as determined from the first electrical signal and the electric field amplitude of the low pass terahertz radiation as determined from the second electrical signal.

In some embodiments, the frequency components of the outgoing broadband terahertz radiation are successively filtered by a plurality of frequency selective surfaces formed in a rotating disc, generating the at least one electrical signal comprises generating a plurality of filter signals associated with the frequency components of the outgoing broadband terahertz radiation successively filtered by the plurality of frequency selective surfaces, and spectroscopy of the sample is performed by computing the ratio between an electric field amplitude of each of the plurality of filter signals and the electric field amplitude of the reference signal.

In some embodiments, the frequency components of the outgoing broadband terahertz radiation are successively filtered by a first plurality and a second plurality of frequency selective surfaces formed in a rotating disc, the first plurality of frequency selective surfaces oriented in a vertical polarization direction and the second plurality of frequency selective surfaces oriented in a horizontal polarization direction, generating the at least one electrical signal comprises generating a first electrical signal associated with the frequency components of the outgoing broadband terahertz radiation filtered by each the first plurality of frequency selective surfaces and a generating second electrical signal associated with the frequency components of the outgoing broadband terahertz radiation filtered by each of the second plurality of frequency selective surfaces, and spectroscopy of the sample is performed based on the ratio between the first electrical signal and the second electrical signal.

In accordance with yet another aspect, there is provided a terahertz radiation filter for use in performing frequency selective terahertz spectroscopy of a sample, comprising a rotating disc and a plurality of frequency selective surfaces radially formed in the rotating disc, the plurality of frequency selective surfaces configured to successively filter, as the disc rotates, frequency components of broadband terahertz radiation incident on the rotating disc and to generate filtered narrowband terahertz radiation based on the broadband terahertz radiation.

In some embodiments, the plurality of frequency selective surfaces comprises a first plurality of frequency selective surfaces oriented in a vertical polarization direction and a second plurality of frequency selective surfaces oriented in a horizontal polarization direction.

Many further features and combinations thereof concerning embodiments described herein will appear to those skilled in the art following a reading of the instant disclosure.

### DESCRIPTION OF THE FIGURES

In the figures,

FIG. 1 is schematic diagram of a system for performing frequency selective terahertz spectroscopy of a sample, in accordance with an illustrative embodiment;

FIG. 2 is schematic diagram detailing the filtering unit and the receiving unit of FIG. 1, in accordance with an illustrative embodiment;

FIG. 3A is a graph illustrating reference and measurement electric field amplitudes, as measured using the system of FIG. 2, as well as the measurement electric field amplitude normalized using the reference electric field amplitude, in accordance with an illustrative embodiment;

FIG. 3B is a graph illustrating the electric field amplitude as measured using the system of FIG. 2, for different samples containing different amounts of contaminant, in accordance with an illustrative embodiment;

FIG. 4 is a schematic diagram detailing the filtering unit and the receiving unit of FIG. 1, in accordance with another illustrative embodiment;

FIG. 5A is a schematic diagram of the rotating filter of FIG. 4, in accordance with an illustrative embodiment;

FIG. 5B is a schematic diagram of the rotating filter of FIG. 4, in accordance with another illustrative embodiment;

FIG. 6A is a graph illustrating raw signal data and a reference signal acquired by the terahertz radiation receiver of FIG. 4 for six different samples, in accordance with an illustrative embodiment;

FIG. 6B is a graph illustrating the raw signal data of FIG. 6A normalized relative to the reference signal of FIG. 6A, in accordance with an illustrative embodiment;

FIG. 6C is a graph illustrating the terahertz spectral response of the six samples of FIG. 6A, in accordance with an illustrative embodiment;

FIG. 6D illustrates the frequency response of the complementary split ring resonators (SRR) used in the rotating disc FIG. 5B, in accordance with an illustrative embodiment;

FIG. 6E illustrates the arrangement of the rotating disc of FIG. 5B designed for polarization measurement, in accordance with an illustrative embodiment;

FIG. 6F illustrates the transmitted intensity terahertz signal captured by a Schottky detector for the SRR structures of FIG. 5B, in accordance with an illustrative embodiment;

FIG. 7A is a flowchart illustrating an example method for performing frequency selective terahertz spectroscopy of a sample, in accordance with an illustrative embodiment;

FIG. 7B is a flowchart illustrating the step of FIG. 7A of filtering frequency components of an outgoing broadband terahertz radiation using the system of FIG. 1 having the filtering unit of FIG. 2, in accordance with an illustrative embodiment;

FIG. 7C is a flowchart illustrating the step of FIG. 7A of generating at least one electrical signal based on filtered narrowband terahertz radiation using the system of FIG. 1 having the filtering unit and the receiving unit of FIG. 2, in accordance with an illustrative embodiment;

FIG. 7D is a flowchart illustrating the step of FIG. 7A of performing spectroscopy of a sample using the system of FIG. 1 having the filtering unit and the receiving unit of FIG. 2, in accordance with an illustrative embodiment;

FIG. 7E is a flowchart illustrating the step of FIG. 7A of filtering frequency components of an outgoing broadband terahertz radiation using the system of FIG. 1 having the filtering unit and the receiving unit of FIG. 4, in accordance with another illustrative embodiment;

FIG. 8 is a block diagram of an example computing device, in accordance with an illustrative embodiment.

It will be noticed that throughout the appended drawings, like features are identified by like reference numerals.

### DETAILED DESCRIPTION

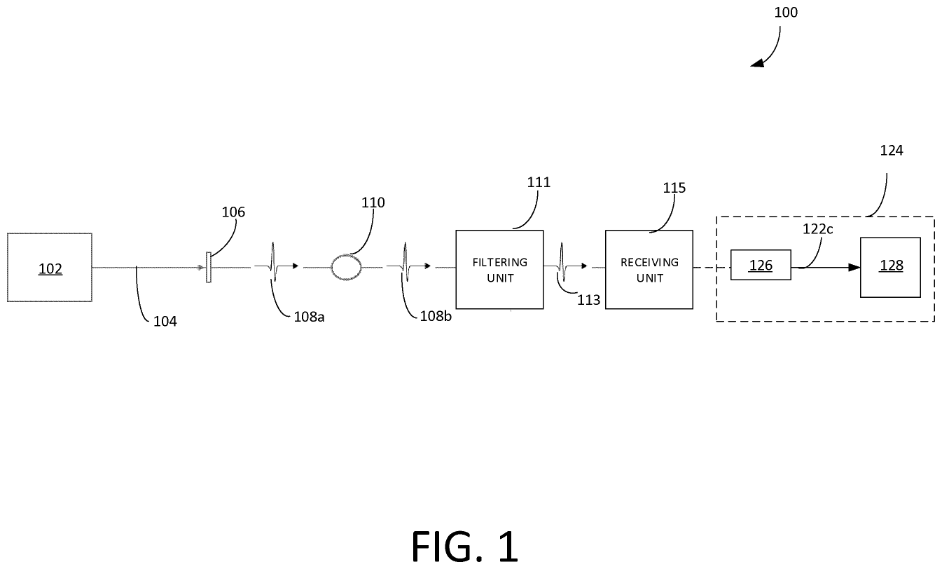

Referring to FIG. 1, a system 100 for performing frequency selective terahertz spectroscopy of a sample, for instance a sample 110, will now be described in accordance with one embodiment. As used herein, the term “terahertz” encompasses frequencies that lie near the commonly accepted boundaries of the terahertz region of the electromagnetic spectrum, which is at the far end of the infrared band, after the end of the microwave band. The terahertz region corresponds to millimeter and submillimeter wavelengths between about 3 mm and about 0.03 mm. As used herein, the terahertz region should be understood to be between about 0.1 THz to about 10 THz.

The system 100 comprises a laser source 102 provided to generate laser pulses (also referred to herein as a “pulse train”) which are passed via a light-conducting fiber assembly 104 towards a terahertz radiation emitter 106. While a fiber assembly 104 is shown and described herein for illustrative purposes, it should be understood that the laser source 102 may be optically coupled to the terahertz radiation emitter 106 via any suitable medium such as air. In some embodiments, the laser source 102 may be configured to generate laser pulses having a pulse duration in the order of femtoseconds (fs) or nanoseconds (ns). In some embodiments, the laser source 102 is a compact fiber-based femtosecond (fs) laser. Other laser technologies can also be considered, including, but not limited to, gas lasers, solid-state lasers, liquid lasers, or semiconductor lasers. For example, Ti:Sapphire, Ytterbium-doped, Erbium, and other femtosecond lasers may apply. The laser source 102 may also comprise one or more electronically-based terahertz pulse emitters, such as THz pulse emitters using Complementary metal-oxide-semiconductor (CMOS) technology.

The parameters associated with the laser source 102 and/or the pulse train (e.g., halfwidth, repetition rate, output power, and/or center wavelength) may vary depending on the application. In some embodiments, the halfwidth is less than or equal to 80 fs, the repetition rate is between about 80 MHz and about 100 MHz, the output power is greater than or equal to 100 mW, and the center wavelength is around 1560 nm, for instance 1560 nm+/−10 nm. In one embodiment, the laser source 102 is configured to emit pulses of 100 fs at 800 nm with a power of 2 W at a repetition rate of 80 MHz, such that the time interval between two consecutive pulses of the pulse train (given by the inverse repetition rate) is 12.5 ns. Other embodiments may apply.

The pulse train propagates from the laser source 102 through the fiber assembly 104, which directs the pulse train towards the terahertz radiation emitter 106. The fiber assembly 104 may be configured to attenuate the pulse train in order to decrease the output power of the pulse train (for example, to about 20 mW), and/or to modify the shape of pulses in the pulse train before the latter is passed to the terahertz radiation emitter 106, using any suitable technique. In some embodiments, the fiber assembly 104 may be provided as a fiber pigtail. In some embodiments, the fiber assembly 104 may be a single-mode, polarization maintaining fiber. In some embodiments, the fiber assembly 104 may comprise one or more dispersion-compensating fibers which are spliced into the fiber-optic beam path. Other fiber technologies can also be considered, including, but not limited to, multi-mode fiber.

The terahertz radiation emitter 106 is optically coupled to the laser source 102 and to the sample 110 and configured to convert the pulse train into a first (or incident) terahertz radiation beam 108a. In one embodiment, the terahertz radiation emitter 106 may comprise an antenna (also referred to herein as an “emitter antenna”), such as a photoconductive antenna or PCA (not shown), for receiving the pulse train, and a photoconductive switch (not shown) for emitting the incident terahertz radiation beam 108a. In some embodiments, the emitter antenna may comprise a strip-line antenna. Other antenna technologies can also be considered. For example, the emitter antenna may comprise, but is not limited to, an omni-directional antenna, a braided antenna, a double-braided polyester rope, a spider antenna loop antenna, an air coil loop antenna, a sparrow antenna, a Yagi-Uda antenna, an interdigital photoconductive antenna, a Low temperature (LT) Gallium arsenide (GaAs) photoconductive antenna (PCA), or any other suitable type of antenna. In some embodiments, the photoconductive switch may comprise an Indium gallium arsenide (InGaAs) or Indium phosphide (InP) photoconductive switch. It should be understood that the terahertz radiation emitter 106 may comprise any suitable terahertz pulse generator. An optical rectification process, in Gallium phosphide (GaP), Lithium Niobate, Zinc telluride (ZnTe), DAST (4-N,N-dimethylamino-4′-N′-methylstilbazolium tosylate), OH1 (2-(3-(4-hydroxystyryl)-5,5-dimethylcyclohex-2-enylidene) malononitrile), and all known nonlinear crystal for THz pulse generation may also be used. Terahertz via spintronic emitters (which do not require any specific polarization for emitting THz pulses) may also be used. Other embodiments may therefore apply.

In some embodiments, the incident terahertz radiation beam 108a may be generated by the laser source 102 as collimated light through a silicone (Si) lens (not shown). A further lens (not shown) may be provided prior to the sample 110 to maximize the signal at the detection position.

In some embodiments, the terahertz radiation emitter 106 converts the optical pulse train received from the laser source 102 with an average power of about 25 μW. The incident terahertz radiation beam 108a further has a spectrum containing frequencies within the terahertz region. In particular, the spectral width of the incident terahertz radiation beam 108a may range from about 0.1 THz to about 5 THz, preferably from about 0.1 THz to about 2 THz, and more preferably from about 0.1 THz to about 1.5 THz. It should however be understood that the spectral width of the incident terahertz radiation beam 108a depends on the type of sample 100 being analyzed and may thus vary depending on the application.

The terahertz radiation emitter 106 may be caused to emit the incident terahertz radiation beam 108a (along a given optical path, not shown) to be incident on the sample 110 for the incident terahertz radiation beam 108a to radiate through the sample 110. The incident terahertz radiation beam 108a is expected to have a spectral width greater than the terahertz absorption frequency of the sample 110 so that a spectral power distribution of the incident terahertz radiation beam 108a is modified depending on the transmission properties of the sample 110 (i.e. absorption and reflection losses in the material composing the sample 110 under test). Generally, the greater the transmission properties, the more the sample 110 will absorb, scatter and/or diffract power at the terahertz resonance or absorption frequency. Conversely, the lower the transmission properties, the lesser the sample 110 will absorb and/or diffract power at the terahertz resonance frequency. In some embodiments, the terahertz radiation emitter 106 is a broadband emitter such that the incident terahertz radiation beam 108a is broadband (also referred to herein as “incident broadband terahertz radiation”) and has power at the terahertz resonance frequency of the sample 110 but also at other surrounding frequencies, spectrally-spaced from the terahertz resonance frequency. In other words, in some embodiments, the incident terahertz radiation beam 108a has power within a given range of frequencies including the terahertz resonance frequency, and/or the transmission/reflection frequency band among other frequencies.

As used herein, the term “broadband” (sometimes referred to as “wideband”) refers to radiation that covers (or occupies) a large portion of the frequency spectrum (i.e. a wide range of frequencies), in contrast to the term “narrowband”, which, as used herein, refers to radiation that covers (or occupies) a small portion of the frequency spectrum (i.e. a narrow range of frequencies). In other words, broadband radiation takes up a larger fraction of the frequency spectrum than narrowband radiation. In the embodiments described herein, broadband terahertz radiation should be understood as radiation that occupies a spectral width ranging from about 0.1 THz to about 5 THz, preferably from about 0.1 THz to about 2 THz, and more preferably from about 0.1 THz to about 1.5 THz, as noted above. In contrast, as used herein, narrowband terahertz radiation should be understood as radiation that occupies a spectral width lower than about 100 GHz.

The sample 110 may be optically coupled to the terahertz radiation emitter 106 and to a terahertz radiation filtering unit 111 by any suitable means. The sample 110 may comprise any material or device under test by the system 100. The sample 110 may comprise, for example, foodstuff, organic material such as biological tissue, vegetal materials (e.g., plants, seeds), fabric material (clothing, shoes, etc.), paper, plastic, composite materials, electronics or semiconductor devices such as printed circuit boards (PCBs), or mail envelopes and parcels, among other possibilities. Depending on the transmission properties of the sample 110, the sample 110 may at least partially absorb and/or reflect the incident terahertz radiation beam 108a, and emit a second (or outgoing) terahertz radiation beam 108b towards the terahertz radiation filtering unit 111. The outgoing terahertz radiation beam 108b corresponds to the frequency content of the incident terahertz radiation beam 108a passing through the sample 110. The terahertz radiation filtering unit 111 is configured to filter the outgoing terahertz radiation beam 108b emitted by the sample 110 to generate filtered narrowband radiation 113. The filtered narrowband radiation 113 is then received at a receiving unit 115 for use in performing spectroscopy of the sample 110, as will be described further below.

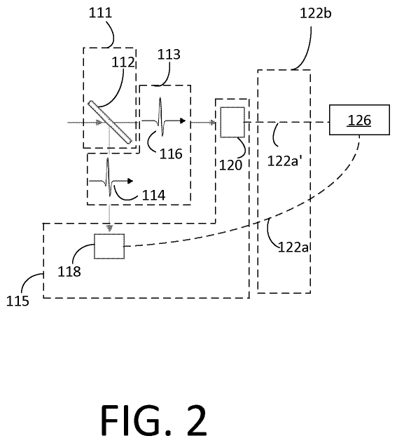

In one embodiment illustrated in FIG. 2, the terahertz radiation filtering unit 111 comprises a terahertz radiation filter 112 configured to separate the outgoing terahertz radiation beam 108b into two narrowband radiation beams within different frequency bands, namely a high-pass (HP) radiation beam 114 within a high frequency band (or range), i.e. above a given cut-off frequency, and a low-pass (LP) radiation beam 116 within a low frequency band (or range), i.e. below the cut-off frequency. In other words, in the embodiment of FIG. 2, the terahertz radiation filtering unit 111 generates the filtered narrowband radiation 113 comprising HP radiation beam 114 and LP radiation beam 116. In particular, the terahertz radiation filter 112 is a LP filter configured to filter (i.e. reflect) the high frequency (i.e. above the cut-off frequency) component of the outgoing terahertz radiation beam 108b to generate the HP radiation beam 114, and to absorb (or pass) the low frequency (i.e. below the cut-off frequency) component of the outgoing terahertz radiation beam 108b to generate the LP radiation beam 116. The cut-off frequency of the terahertz radiation filter 112 may depend on the application (i.e. on the type of sample 110 being analyzed) as well as on optical and/or geometrical properties of the terahertz radiation filter 112. Any dual frequency band (narrow or broadband), low pass frequency band, or high pass frequency band within the THz range may be used to set the cut-off frequency. In one embodiment, the cut-off frequency is 0.32 THz. Other embodiments may apply. Using the terahertz radiation filter 112, the system 100 of FIG. 2 may be used to perform dual-band terahertz spectroscopy of the sample 110.

The sample 110 illustratively comprises a matrix and contaminant(s) (or other particle(s)) having different absorption slopes. Thus, depending on the sample's composition, each frequency band (i.e. LP versus HP) has a distinct behaviour within the sample 110. As a result, the ratio between the electric field amplitudes of the HP and LP radiation beams 114, 116 will vary and can be used as an indication of the unique signature of any contaminant (or other particle) contained in the sample 110, as will be described further below.

In order to detect the presence (or absence) of one or more contaminants (or other particle(s) of interest) contained in the sample 110, the terahertz radiation filter 112 is optically coupled to the receiving unit 115 which, in the embodiment of FIG. 2, comprises a first terahertz radiation receiver 118 and a second terahertz radiation receiver 120. The terahertz radiation filter 112 is configured to direct the HP radiation beam 114 towards the first terahertz radiation receiver 118 and to direct the LP radiation beam 116 towards the second terahertz radiation receiver 120. In some embodiments, the terahertz radiation filter 112 is a passive component. In some embodiments, the terahertz radiation filter 112 may comprise a metal foil with a two-dimensional array of holes, where the configuration of holes may depend on the wavelength to be filtered. In some embodiments, the holes may be substantially circular. In some embodiments, the outgoing terahertz radiation beam 108b may be incident upon a terahertz metasurface, wiregrid polarizer, frequency selective surface, or three-dimensional (3D) metamaterial (not shown) of the terahertz radiation filter 112.

The first terahertz radiation receiver 118 is sensitive to (i.e. has a sensitivity band in) the low frequency band of the incident terahertz radiation beam 108a and the second terahertz radiation receiver 120 is sensitive (i.e. has a sensitivity band in) to the high frequency band of the incident terahertz radiation beam 108a. Upon receipt of the filtered terahertz radiation beam 113 (e.g., of the HP and LP radiation beams 114, 116), the receiving unit 115 (e.g., each of the first terahertz radiation receiver 118 and the second terahertz radiation receiver 120) is configured to emit an electrical signal proportional to the intensity (i.e. electric field amplitude) of the filtered terahertz radiation beam 113 (e.g., of the HP radiation beam 114 and the LP radiation beam 116). In some embodiments, the receiving unit 115 (e.g., each terahertz radiation receiver 118, 120) is a time domain spectroscopy (THz-TSD) receiver which measures an amplitude of the electric field (referred to herein as “electric field amplitude”) of the filtered terahertz radiation beam 113 (e.g., of the HP and LP radiation beams 114, 116) as a function of time, and which is configured to perform a Fourier transform of that signal to provide amplitude as a function of frequency.

In some embodiments, the receiving unit 115 (e.g., the first terahertz radiation receiver 118 and the second terahertz radiation receiver 120) may also be configured to process filtered terahertz radiation beam 113 (e.g., the HP radiation beam 114 and the LP radiation beam 116). The processing performed by the receiving unit 115 (e.g., the receivers 118, 120) may include amplifying, sampling, and/or broadening in time of the filtered terahertz radiation beam 113 (e.g., of the HP radiation beam 114 and/or of the LP radiation beam 116). It should however be understood that the receiving unit 115 (e.g., the terahertz radiation receivers 118, 120) may comprise any type of suitable terahertz radiation receiver such as a terahertz spectrometer or imager, for instance. The receiving unit 115 (e.g., may comprise a THz pulse energy meter, such as a Schottky diode receiver, configured to measure a signal proportional to the THz energy per pulse.

In some embodiments, the receiving unit 115 (e.g., the first terahertz radiation receiver 118 and the second terahertz radiation receiver 120) has a measurement rate greater than the repetition rate of the pulse train emitted by the laser source 102. For instance, the first terahertz radiation receiver 118 and the second terahertz radiation receiver 120 may have a measurement rate greater than 80 MHz. In some embodiments, the first terahertz radiation receiver 118 and the second terahertz radiation receiver 120 may each comprise an antenna (also referred to herein as a “receiver antenna”, not shown) connected to detector circuitry comprising a Schottky diode (also referred to as a Schottky receiver or a Schottky detector). The Schottky diode has a usable frequency range (or bandwidth) that matches the peak power of the filtered terahertz radiation beam 113 (e.g., of the HP and LP radiation beams 114, 116). In some embodiments, the receiving unit 115 (e.g., the first terahertz radiation receiver 118 and the second terahertz radiation receiver 120) may additionally comprise an amplifier (not shown) for converting the output of the Schottky diode to voltage signals. The amplifier may be characterized by a given bandwidth, for instance 4 GHz. Other possibilities may also apply. It should also be understood that each of the first terahertz radiation receiver 118 and the second terahertz radiation receiver 120 may comprise any suitable device, including, but not limited to, a power or energy meter suitable for the frequency range concerned.

Referring back to FIG. 1, the system 100 further comprises a computing unit 124 communicatively coupled to the receiving unit 115 and configured to receive therefrom the electrical signal(s) generated based on the filtered narrowband radiation 113. In the embodiment of FIG. 2, communication between components of the computing unit 124, the first terahertz radiation receiver 118 and the second terahertz radiation receiver 120 may occur via a first transmission link 122a and a second transmission link 122a′, respectively. In some embodiments, the first transmission link 122a and the second transmission link 122a′ may be wired, wireless, or a combination of wired and wireless connections. The first transmission link 122a and the second transmission link 122a′ may comprise a communications cable, for instance coaxial cable, twisted pair cable, or fiber optic cable, among other possibilities. In some embodiments, the first transmission link 122a and the second transmission link 122a′ may be provided as part of a network 122b. The network 122b may be any type of network or combination of networks for carrying data communications. Such a network may comprise, for example, a Personal Area Network (PAN), Local Area Network (LAN), Wireless Local Area Network (WLAN), Metropolitan Area Network (MAN), or Wide Area Network (WAN), such as the Internet, or combinations thereof. In some embodiments, the receiving unit 115 may communicate with the computing unit 124 via a private network (e.g. an “intranet”).

In some embodiments, the computing unit 124 may comprise a data acquisition unit 126 communicatively coupled to the receiving unit 115 (e.g., to the first terahertz radiation receiver 118 and to the second terahertz radiation receiver 120 via the first transmission link 122a and the second transmission link 122a′, respectively) for recording and processing signals received therefrom to generate output data. In one embodiment, the data acquisition unit 126 is an analog-to-digital converter (ADC). The data acquisition unit 126 may be communicatively coupled to a data analysis unit 128 and configured to send the output data thereto, for instance via a transmission link 122c. The data acquisition unit 126 may be characterized by a sampling rate, for instance 5 GS/s. In some embodiments, the data acquisition unit 126 and the data analysis unit 128 are provided as separate units integrated into the computing unit 124, as illustrated in FIG. 1. It should however be understood that the data acquisition unit 126 and the data analysis unit 128 may be provided as a single unit.

The data analysis unit 128 may be configured to run computer-executable instructions for analyzing the data received from the data acquisition unit 126. The analysis performed by the data analysis unit 128 may comprise spectral analysis (i.e. spectroscopy) performed based on a ratio between at least one electrical signal received from the receiving unit 115 and a reference signal. This may be achieved using the following equation:

$$I = \frac{Fi\_signal}{Ref\_signal} \qquad ( 1 )$$

where I is the computed ratio, Fi_signal is the at least one electrical signal received from the receiving unit 115, and Ref_signal is the reference signal.

In the embodiment of FIG. 2, the Fi_signal may be represented by the HP component of the outgoing terahertz radiation beam 108b and the Ref_signal may be represented by the LP component of the outgoing terahertz radiation beam 108b. In particular, the data analysis unit 128 may be configured to compute a ratio of the electric field amplitude of the HP radiation beam 114 to the electric field amplitude of the LP radiation beam 116 using the following equation:

$$I = \frac{{\int }_{{ω}_{1}}^{{ω}_{2}} {E}_{sam} ( ω ) d ω}{{\int }_{{ω}_{3}}^{{ω}_{4}} {E}_{ref} ( ω ) d ω} = \frac{{I}_{sam}}{{I}_{ref}} \qquad ( 2 )$$

where I is the computed ratio, ω represents frequency, Eₛₐₘ is the electric field amplitude of the HP radiation beam 114, E_{ref} is electric field amplitude of the LP radiation beam 116, I_{ref} is the THz intensity defined by the low frequency region between frequencies ω₁ and ω₂, and Iₛₐₘ is the THz intensity of the absorption or resonance of the sample defined by the high frequency region between frequencies ω₃ and ω₄.

The ratio computed using equation (1) is a relative measure that may be used to scan a sample in two dimensions. Thus, the “normal zone”, following a calibration on a so-called “normal range”, is within an acceptable range and any change outside this zone is noted as problematic or outside the acceptable range (e.g. presence of a contaminant, change in behavior or change in structure). In particular, based on the data received from the data acquisition unit 126 (e.g., the electric field amplitude of the HP and LP radiation beams 114, 116), the computing unit 124 is configured to determine whether one or more contaminants (or other particle(s) of interest) are present in the sample 110 using the ratio computed with equation (1) above. The computing unit 124 may also be configured to quantify the amount of contaminant present in the sample 110. The computing unit 124 may further be configured to compare the amount of contaminant to a given threshold and to trigger an alert or other signal when the amount of contaminant is above the given threshold.

In some embodiments, the system 100 may be integrated into a production system, an assembly line, or the like, for performing dual-band terahertz spectroscopy on a product, a manufactured good, a material, or the like. The system 100 may perform dual-band terahertz spectroscopy in real-time, for instance during a production or assembly process.

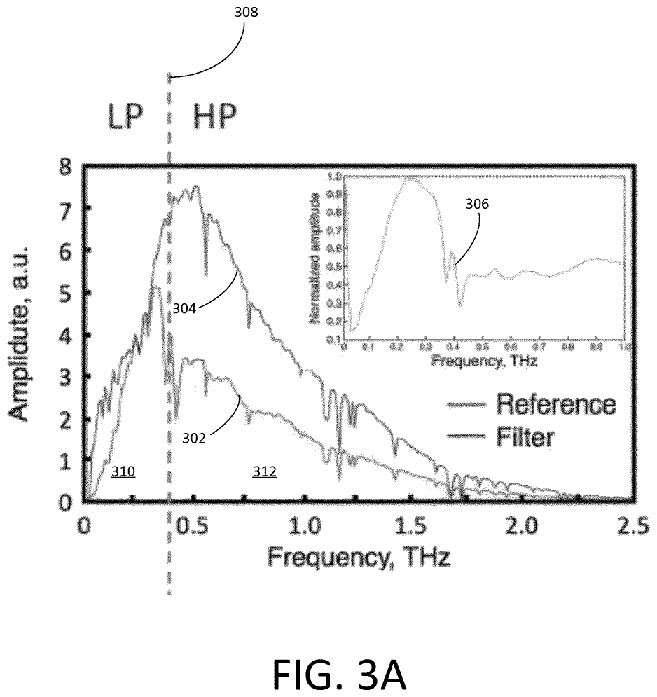

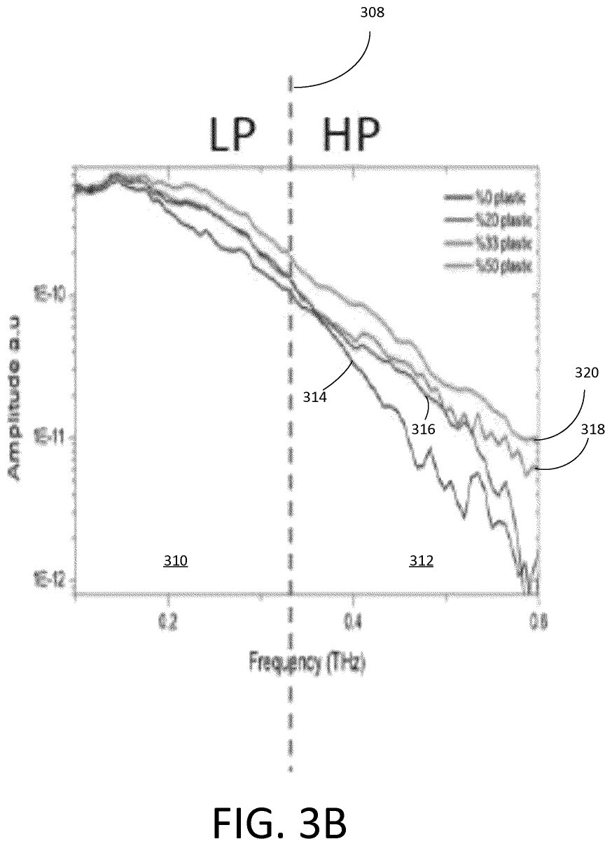

FIG. 3A illustrates examples of data received at the computing unit 124, using the system 100 of FIG. 1 with a terahertz radiation filtering unit 111 and a receiving unit 115 as illustrated in FIG. 2. Plot 302 illustrates a reference electric field amplitude (in arbitrary units, a.u.) measured as a function of frequency (in THz), as measured for instance using a terahertz radiation reference receiver (discussed above), and plot 304 illustrates the electric field amplitude (referred to herein as the “measurement electric field amplitude”) measured as a function of frequency using the first and second terahertz radiation receivers 118, 120 of FIG. 2. Plot 306 illustrates the measurement electric field amplitude normalized using the reference electric field amplitude. As can be seen from FIG. 3A, in the LP frequency range 310 (i.e. below the cut-off frequency 308), the difference between the reference and measured electric field amplitudes (i.e. the difference between plots 302 and 304) is negligible (e.g., in the order of 1 a.u.). This is indicative of the fact that the LP component of the terahertz radiation passes through the terahertz radiation filter 112, as described herein above with reference to FIG. 2. In contrast, in the HP frequency range 312 (i.e. above the cut-off frequency 308), a greater difference (e.g., up to about 5 a.u.) is seen between the reference and measured electric field amplitudes (i.e. between plots 302 and 304). This is indicative of the fact that the HP component of the terahertz radiation is reflected by the terahertz radiation filter 112, as described herein above with reference to FIG. 2.

FIG. 3B illustrates the electric field amplitude (in arbitrary units, a.u.) measured as a function of frequency (in THz) using the system 100 of FIG. 1 with a terahertz radiation filtering unit 111 and a receiving unit 115 as illustrated in FIG. 2, for different samples containing different amounts of contaminant(s). Plots 314, 316, 318, and 320 may characterize a sample, for instance the sample 110, containing varying amounts of an added contaminant, for instance plastic, when subjected to terahertz radiation, for instance to the incident terahertz radiation beam 108a. In the illustrated embodiment, the plot 314 characterizes a sample with no (i.e., 0%) contaminant, the plot 316 characterizes a sample with a first amount (e.g., 20%) of contaminant (e.g., plastic), the plot 318 characterizes a sample with a second amount (e.g., 33%) of contaminant greater than the first amount, and the plot 320 characterizes a sample with a third amount (e.g., 50%) of contaminant greater than the third amount.

Below a cut-off frequency 308 of the terahertz radiation filter 112, the LP component (or LP radiation beam 116) of the outgoing terahertz radiation beam 108b is plotted in the LP frequency band 310, while above the cut-off frequency 312 of the terahertz radiation filter 112, the HP component (or HP radiation beam 114) of the outgoing terahertz radiation beam 108b is plotted in the HP frequency band 312. In some embodiments, attenuation of the plots 314, 316, 318, and 320 may be observed with increasing frequency. Depending on the absorption slopes of the plots 314, 316, 318, and 320, the amount of contaminant in the sample (e.g., sample 110) can be determined. For example, in one embodiment, the plot 314 (representing no contaminant added to the sample 110) attenuates faster (i.e. has a greater absorption slope) than the plot 320 (representing a high amount of contaminant added to the sample 110), which has a lower absorption slope. The plots 316 and 318, in turn, may represent intermediate cases between the plots 314 and 320. In some embodiments, the attenuation may be negligible at lower frequencies (e.g. in the left-most portion of LP region 310, and become significant at higher frequencies (e.g. in the right-most portion of HP region 312). It should be understood that the graphs shown in FIG. 3B are illustrative only and that other embodiments may apply.

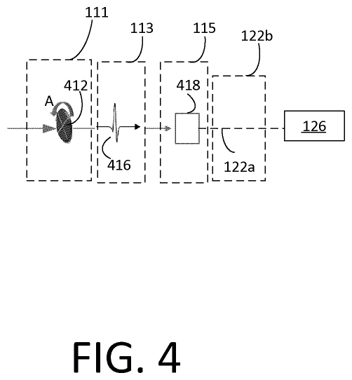

Referring now to FIG. 4 in addition to FIG. 1, in some embodiments the terahertz radiation filtering unit 111 comprises a rotating terahertz radiation filter (also referred to herein as a “rotating filter” or a “filter wheel”) 412 optically coupled to the receiving unit 115 which comprises a terahertz radiation receiver 418. The sample 110 may be optically coupled to the terahertz radiation emitter 106 and to the rotating filter 412 by any suitable means. Using such a rotating filter 412 (sometimes referred to as an “optical chopper” or a “mechanical chopper”), the system 100 of FIG. 1 may be used to perform frequency selective terahertz spectroscopy using a combination of broadband terahertz pulses and a terahertz radiation receiver, e.g., a Schottky detector. In particular, by integrating a mechanical chopper composed of frequency selective surfaces in front of the Schottky detector, samples are identified by combining unique spectral signatures normalized to each filter transmission.

The rotating filter 412 is an active component configured to periodically interrupt a radiation beam incident thereon, thereby modulating the radiation beam's intensity. A plurality of frequency selective surfaces (described further below) may be used to extract amplitude or phase information from the terahertz waves incident on the rotating filter 412. In particular, the rotating filter 412 may be configured to split the outgoing terahertz radiation beam 108b (i.e. the radiation after the sample 110) into two or more optical paths and may, as such operate as a spectral beam splitter. The rotating filter 412 may then redirect a portion of the outgoing terahertz radiation beam 108b towards a second terahertz radiation receiver (not shown). Using the second terahertz radiation receiver, balanced values (i.e., between the first terahertz radiation receiver 418 and the second terahertz radiation receiver) may be measured and communicated to the computing unit 124 for comparison.

The rotating filter 412 may comprise any suitable device and may be manufactured using any suitable technique. In some embodiments, the rotating filter 412 may be manufactured using one or more laser writing techniques, e.g. on a 70 μm thick stainless steel plate. For instance, a split ring resonator (SRR) may apply, which is a polarization-sensitive device that facilitates the extraction of phase information (i.e. of a polarization state of the terahertz radiation) by generating an intensity signal proportional to its filtering level. Another embodiment involves manufacturing the rotating filter 412 by creating arrays of several hundred micron-diameter holes, as will be described further below. The hole arrays may be formed, for example, by drilling into a 70 μm thick stainless steel plate. This in turn acts as a band-pass filter, allowing the retrieval of amplitude information from THz waves at specific frequencies.

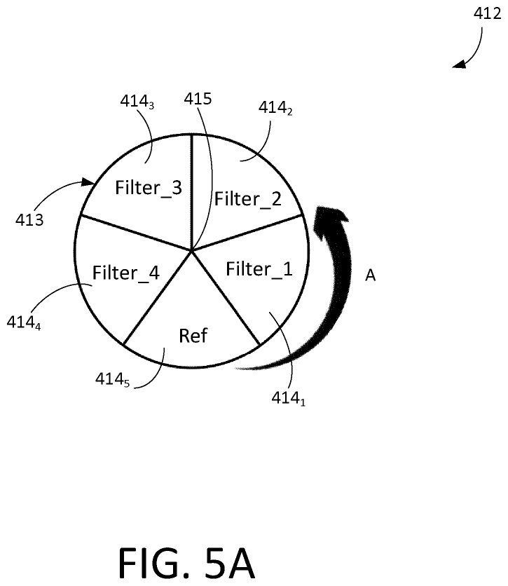

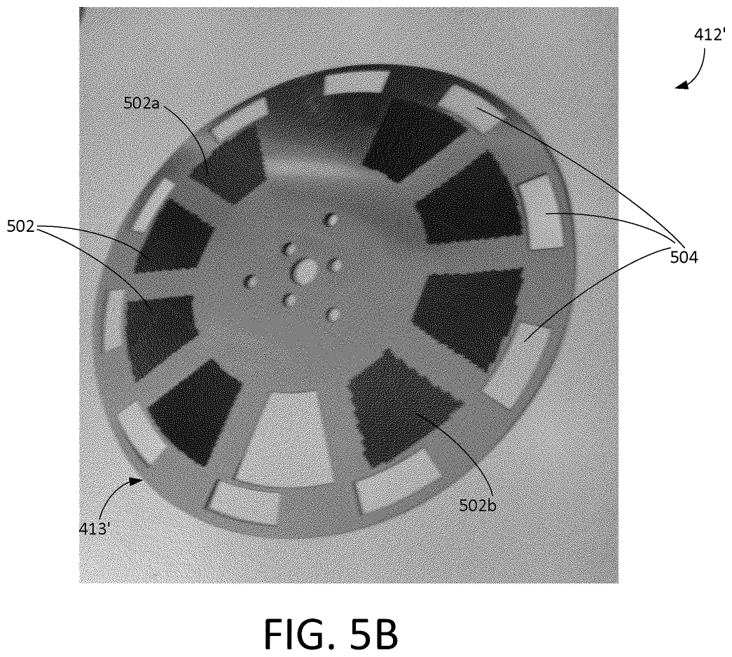

Referring to FIG. 5A, in one embodiment, the rotating filter 412 is shaped as a disc having a pattern of openings (or slots) formed therein, the openings defining the different frequency selective surfaces (also referred to herein as “blades”) of the rotating filter 412. In one embodiment, the frequency selective surfaces (i.e. the blades) are formed so as to extend radially as illustrated in FIG. 5A. As the rotating filter 412 rotates (in a direction indicated by arrow A in FIG. 4 and FIG. 5A), the blades alternate such that the terahertz radiation beam is successively exposed to (i.e. passes through) the different blades of the rotating filter 412. In one embodiment, each blade is configured to allow through (i.e. pass) terahertz radiation within a given frequency band (or range, also referred to as a “passband”), resulting in a filtered terahertz radiation beam 416 being output from the rotating filter 412. In other words, each blade operates as a bandpass (BP) filter. In one embodiment, the bandpass filters do not have a sharp bandpass function but rather have a complex transmission shape in the relevant frequency range.

In the embodiment illustrated in FIG. 5A, the rotating filter 412 comprises a disc 413 with five (5) blades 414₁, 414₂, 414₃, 414₄, and 414₅ extending radially away from a center 415 of the disc 413. Each blade 414₁, 414₂, 414₃, 414₄ is configured to operate as a bandpass filter that passes components of terahertz radiation beams (e.g., of the outgoing terahertz radiation beam 108b) within a given frequency band. Blade 4145 is configured to operate as a reference blade (i.e. with no filter) that passes terahertz radiation regardless of their frequency and generates a reference signal. The bandpass filters associated with blades 414₁, 414₂, 414₃, 414₄ may have any suitable center frequency. For example, the first bandpass filter implemented by the first blade 414₁ may have a center frequency of 170 GHz, the second bandpass filter implemented by the first blade 414₂ may have a center frequency of 176 GHZ, the third bandpass filter implemented by the first blade 414₃ may have a center frequency of 228 GHZ, and the fourth bandpass filter implemented by the first blade 414₄ may have a center frequency of 230 GHz. Other embodiments may apply.

While five (5) blades 414₁, 414₂, 414₃, 414₄, and 414₅ are illustrated in FIG. 5A, it should be understood that the rotating filter 412 may comprise any suitable number of blades. Furthermore, the rotating filter 412 may be driven by any suitable means (e.g., an electric motor (not shown), a rare earth magnet direct current (DC) motor (not shown), or the like) at any suitable rotation frequency. The rotating filter 412 may be made of any suitable material (e.g., steel), and manufactured using any suitable technique. In one embodiment, a foil stamping technique on a flexible plastic substrate may be used to obtain a custom filter that may be bonded to a 5-blade mechanical wheel to create the rotating filter 412. Other embodiments may apply.

While reference is made herein to the rotating filter 412 being configured to filter the outgoing terahertz radiation beam 108b emitted by the sample 110 by passing, e.g. using blades as in 414₁, 414₂, 414₃, 414₄, components of the outgoing terahertz radiation beam 108b that are within given passbands, it should be understood that, in other embodiments, the rotating filter 412 may be configured to separate the outgoing terahertz radiation beam 108b into two or more radiation beams within different frequency bands, e.g., a high-pass (HP) radiation beam (not shown) within a high frequency band (or range), i.e. above a given cut-off frequency, and a low-pass (LP) radiation beam (not shown) within a low frequency band (or range), i.e. below the cut-off frequency. In particular, in one embodiment, at least one of the blades 414₁, 414₂, 414₃, 414₄ of the rotating filter 412 may operate as a HP filter configured to filter (i.e. pass) a high frequency (i.e. above the cut-off frequency) component of the outgoing terahertz radiation beam 108b to generate the HP radiation beam. In another embodiment, at least one of the blades 414₁, 414₂, 414₃, 414₄ may operate as a LP filter configured to filter (i.e. pass) a low frequency (i.e. below the cut-off frequency) component of the outgoing terahertz radiation beam 108b to generate the LP radiation beam. As described herein above with reference to the terahertz radiation filter 112 of FIG. 2, the cut-off frequency of the rotating filter 412 may depend on the application as well as on optical and/or geometrical properties of the rotating filter 412 and any suitable frequency band within the THz range may be used to set the cut-off frequency.

In the embodiment of FIG. 4, samples can be identified based on their unique spectral signatures. In particular, in order to identify the sample 110 (and optionally detect the presence or absence of one or more contaminants or other particles) of interest contained in the sample 110), the rotating filter 412 may be optically coupled to the terahertz radiation receiver 418. The rotating filter 412 is configured to direct the filtered terahertz radiation beam 416 towards the terahertz radiation receiver 418.

Referring to FIG. 1 in addition to FIG. 4, in one embodiment, in order to improve the discrimination between samples, the data analysis unit 128 performs the spectral analysis 615 using equation (1) above, based on the filtered terahertz radiation signal 416. In the embodiment of FIG. 5A, the rotating disc 412 may be used for intensity measurement at various frequencies and, as such, the information modulated by the rotating filter 412 may form the Fi_signal and the unfiltered information may form the Ref_signal. In particular, the data analysis unit 128 may be configured to compute a ratio between the signal acquired for each filter (implemented by the blades 414₁, 414₂, 414₃, 414₄) and the reference signal (obtained from the reference blade 414₅) using equation (1), where Fi_signal is the signal generated for a given filter i and Ref_signal is the reference signal.

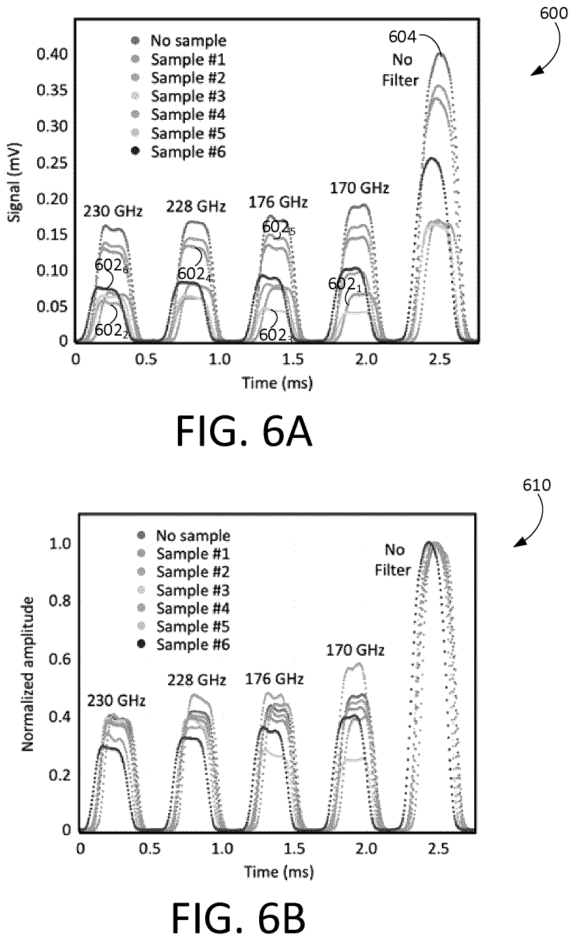

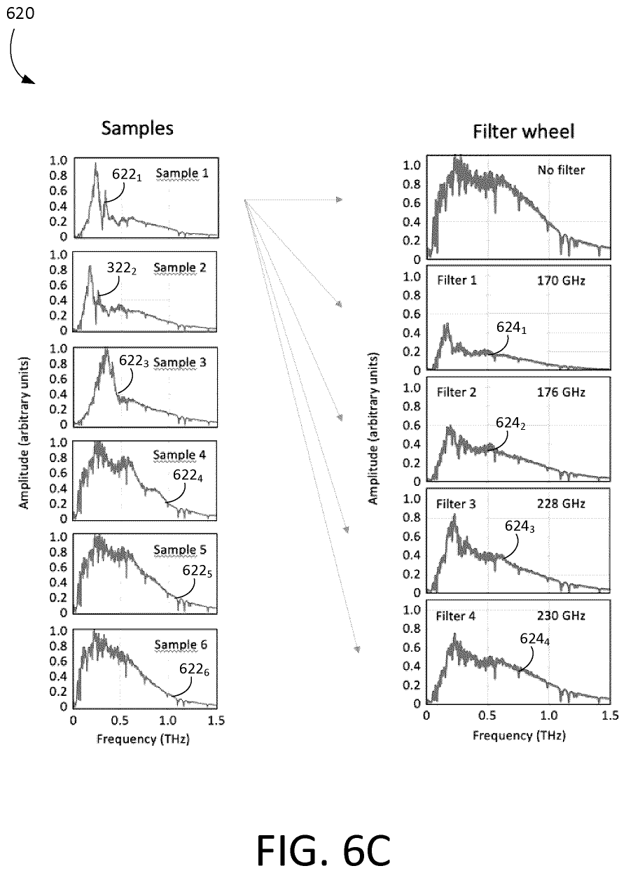

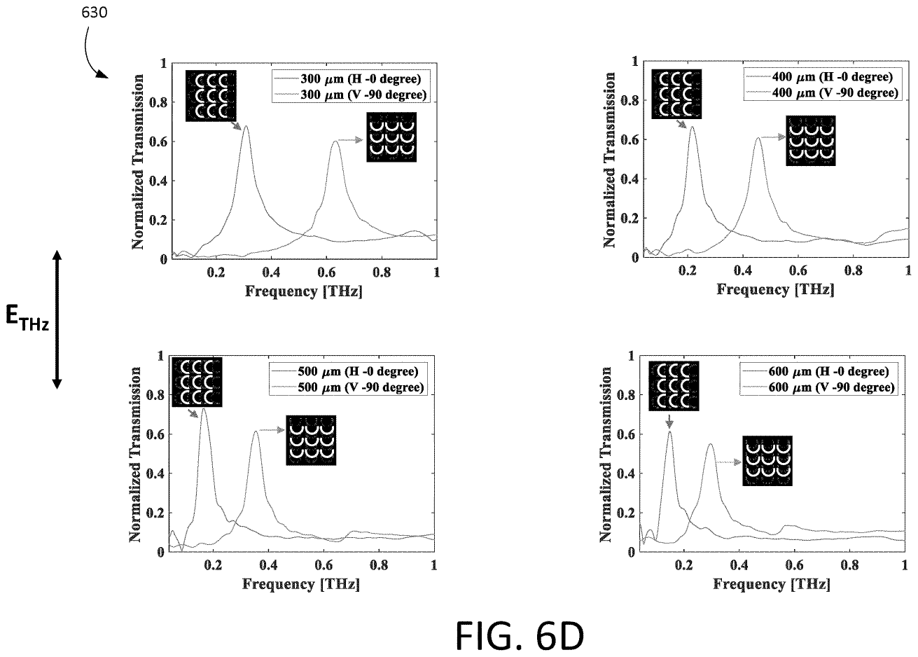

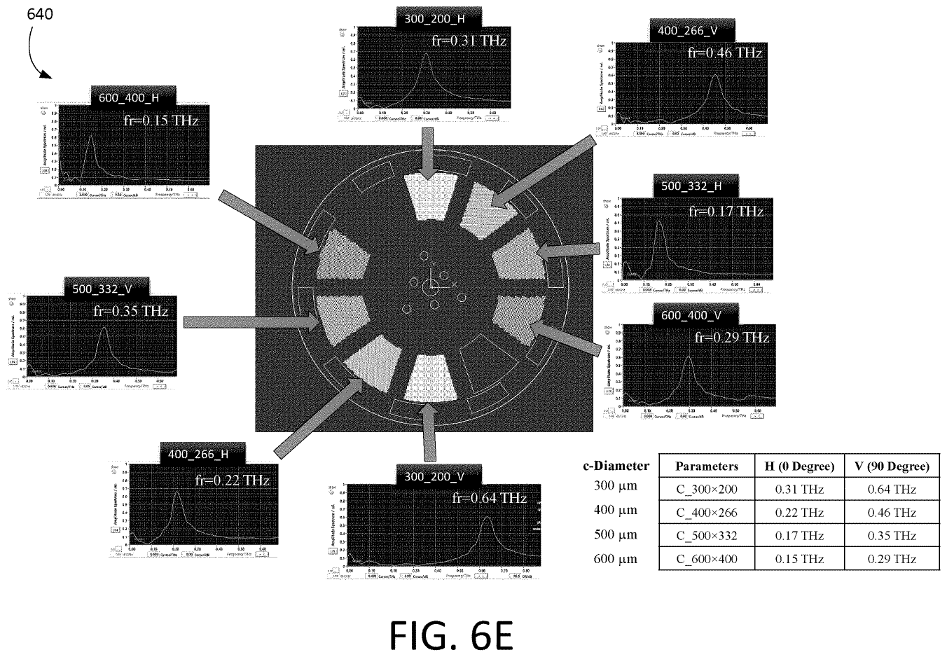

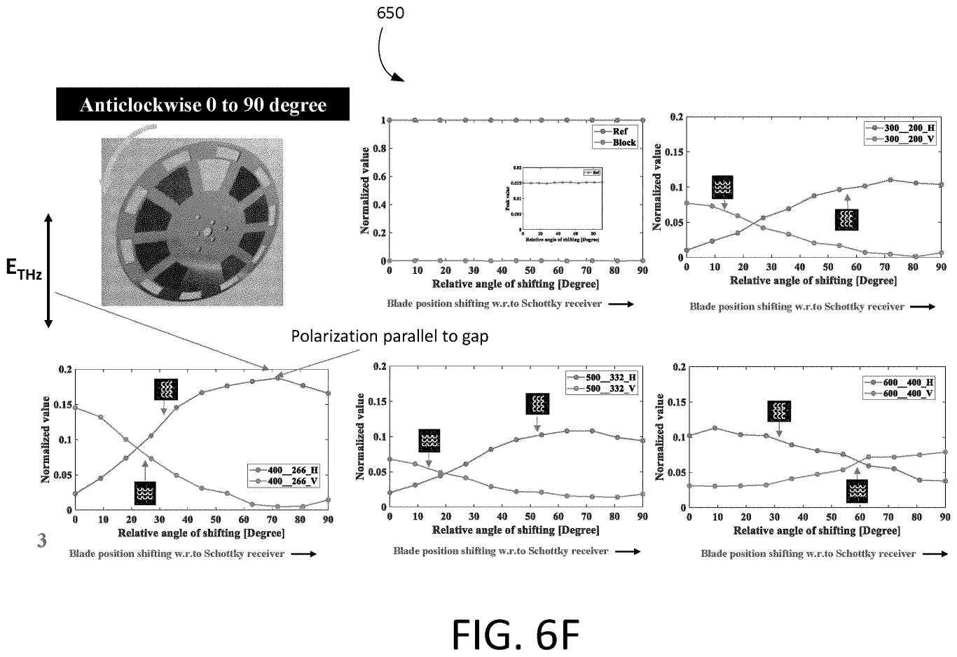

Referring now to FIG. 5B, in another embodiment, a rotating filter 412′ may be used. The rotating filter 412′ illustrated in FIG. 5B is designed for the measurement of terahertz wave polarization. The rotating filter 412′ may be manufactured in any suitable manner. In one embodiment, the rotating filter 412′ may be manufactured using a laser writing procedure on a 70 μm thick stainless-steel foil. The rotating filter 412′ comprises a disc 413′ having a plurality of radially extending frequency selective surfaces (also referred to herein as “SRR structures”) 502 formed therein. A plurality of apertures 504 are also formed adjacent an edge (not shown) of the disc 413′ and are equally spaced around the perimeter of the disc 413′. In the illustrated embodiment, the apertures 504 are used to synchronize the rotation of the disc 413′ with an appropriate controller (not shown), such as a Thorlabs chopper controller (model number MC2000B) or the like. The frequency selective surfaces 502 are arranged in pairs of complementary surfaces, each pair of frequency selective surfaces 502 comprising a first surface 502a oriented in a vertical polarization direction (V), and a second surface 502b positioned diametrically opposite the first surface 502a and oriented in a horizontal polarization direction (H), as will be described further below with reference to FIGS. 6D, 6E, and 6F.

Upon receipt of the filtered terahertz radiation beam 416 generated at the output of the rotating filter 412′, the terahertz radiation receiver 418 is configured to emit at least one electrical signal proportional to the phase (i.e. electric field temporal information) of the filtered terahertz radiation beam 416. With the rotating disc 412′ being used for polarization measurement (i.e. determination of a polarization state of the terahertz radiation) at various frequencies, the data analysis unit 128 performs the spectral analysis using equation (1) above, based on the data received from the terahertz radiation receiver 418. In particular, in this embodiment, the information modulated (i.e. the frequency components of the outgoing broadband terahertz radiation 108b filtered) by a complementary metasurface of the rotating filter 412′ oriented for vertical polarization information (V) may result in the terahertz radiation receiver 418 generating a first electrical signal (corresponding to Fi_signal in equation (1)), and the information modulated by a complementary metasurface of the rotating filter 412 oriented for horizontal polarization information (H) may result in the terahertz radiation receiver 418 generating a second electrical signal (corresponding to Ref_signal in equation (1)).

In some embodiments, the data analysis unit 128 used in the system 100 of FIG. 1 may be configured to implement any suitable machine learning (ML) and/or artificial intelligence (AI) technique to implement target-based qualitative spectroscopy for identification of samples. For example, ML and/or AI techniques may be used to compute the above-mentioned ratios. To improve sensitivity, the ML and/or AI techniques may (alternatively or additionally) be used to compute an integral of the area under each peak of the signal acquired for each filter (e.g., as implemented by the blades 414₁, 414₂, 414₃, 414₄ of FIG. 5A).

This approach using ML and/or AI techniques may be referred to as a modelling pipeline and comprises a data pre-processing step, a feature extraction step, a model training step, and a model evaluation step as follows.

Data pre-processing consists of cleaning and transforming the data to prepare it for analysis. This may involve steps such as removing outliers, normalizing the data and converting categorized variables into numerical values.

Feature extraction involves the identification of the most relevant features of the data that are important for the analysis. For example, in the case of material identification using spectral data, the AI system can extract features such as the intensity of specific wavelengths in the spectrum.

Model training involves inputting the pre-processed data into a machine learning model, such as a neural network, and using it to train patterns in the data. The model is tuned by adjusting its parameters until it can accurately predict the output for a given input.

Model evaluation consists of testing the trained model on new data to assess its accuracy and performance. The model can be further refined based on the results of the evaluation.

FIGS. 6A and 6B illustrate examples of data received at the computing unit 124 when a rotating disc 412 as shown in FIG. 5A is used in the system 100 of FIG. 1. FIG. 6A shows a plot 600 illustrating the response of six (6) different samples as a function of the different transmission of their respective signal after the rotating filter (reference 412 in FIG. 5A), as detected by the terahertz radiation receiver 418 (e.g., by the Schottky diode thereof or any power or energy meter suitable for the frequency range concerned). In this example, the rotating filter 412 is designed with five (5) blades implementing four (4) different terahertz bandpass filters and a reference region (i.e., no filter). This rotating filter 412 is run at 360 Hz and data is obtained in about 3 ms using a fast 14-bit frame grabber operating at 500 MSample/second. Each point in the plot 600 of FIG. 6A is an average value of 10,000 data records from the fast frame grabber, which improves the signal-to-noise ratio (SNR) by about two orders of magnitude.

In FIG. 6A, the measurements are taken for samples comprising a 220 GHz bandpass filter made by screen printing (labelled “Sample #1” and illustrated by curve 6021 in FIG. 6A), a 180 GHz bandpass filter also made by screen printing (labelled “Sample #2” and illustrated by curve 6022 in FIG. 6A), a 300 GHz bandpass filter made by 3D printing (labelled “Sample #3” and illustrated by curve 6023 in FIG. 6A), a standard business card (labelled “Sample #4” and illustrated by curve 6024 in FIG. 6A), a glossy business card (labelled “Sample #5” and illustrated by curve 6025 in FIG. 6A) and an infrared display card (labelled “Sample #6” and illustrated by curve 6026 in FIG. 6A). From plot 600 (which illustrates the raw signal data as a function of time), it can be seen that all samples have different responses directly related to their spectral characteristics. These specificities are best observed if the data is normalized with the reference information (i.e., with the unfiltered signal illustrated by curve 604). The corresponding data is plot 610 of shown in FIG. 6B.

As can be seen from plot 600, samples with transmission at higher frequencies 700 measured with filters having bandpass in the same range records higher voltage and can clearly be identified. Similarly, for samples without distinct terahertz absorption characteristics, small differences in transmission behavior can be revealed using the normalization in FIG. 6B (see, for example, the filter responses for “Sample #4” and “Sample #5”).

Referring now to FIG. 6C, plot 620 illustrates the terahertz spectral response of the six (6) samples described above with reference to FIGS. 6A and 6B, i.e. the signal after the samples have been illuminated by the broadband terahertz emitter 106. The first three (3) samples (labelled “Sample 1”, “Sample 2”, and “Sample 3” in FIG. 6C) show a distinct terahertz response (illustrated by curves 6221, 6222, and 6223 in FIG. 6C) with a clear transmission around 250 GHz, but with a slight distinction from each other. The other three (3) samples (labelled “Sample 4”, “Sample 5”, and “Sample 6” in FIG. 6C) have a smooth response (illustrated by curves 6224, 6225, and 6226 in FIG. 6C) with no spectral characteristics, just a different overall spectral amplitude as a function of frequency. It can therefore be seen that the systems and methods described herein provide the ability to differentiate samples with or without a spectral signature (such as the net absorption line of a molecule).

The sample information passes successively through each filter section (labelled “Filter 1”, “Filter 2”, “Filter 3”, and “Filter 4” in FIG. 6C) of the rotating filter 412 and the resulting spectra is illustrated by curves 6241, 6242, 6243, and 6244 in FIG. 6C. The data is output at the rate of the rotating filter 412 (e.g., 500 MSample/second) and averaged data is obtained (e.g., as shown in FIGS. 6A and 6B for one cycle of the rotating filter 412). A normalization (as in FIG. 6B) is sufficient to differentiate between each of these samples, e.g., by looking at the information in the measurements obtained after the filters. This result confirms that, in some embodiments, with proper training (e.g., using machine learning (ML) and/or artificial intelligence (AI) techniques as described above), target-based qualitative spectroscopy for identification may be implemented.

FIGS. 6D, 6E, and 6E further details the implementation and results obtained when a rotating disc 412′ as shown in FIG. 5B is used in the system 100 of FIG. 1. The plots 630 of FIG. 6D illustrate the frequency response of a matrix of complementary split ring resonators (SRR) with diameters of 300 μm, 400 μm, 500 μm, and 600 μm. In this embodiment,

Using the rotating disc 412′, when a linearly polarized and broadband terahertz wave is directed at the complementary SRR structure oriented in the H direction (referred to as a “Reference response”), the low resonant frequency is transmitted. Similarly, when the terahertz wave is directed at the SRR structure oriented in the V direction (referred to as a “Signal response”), the high resonant frequency is transmitted. The variation in transmission between the signal and reference frequencies is directly proportional to the polarized information carried by the incoming terahertz wave at those specific frequencies.

FIG. 6E illustrates the arrangement of the rotating disc 412′ designed for polarization measurement. Each complementary SRR structure (references 502a, 502b in FIG. 5B) is positioned in a face-to-face manner. For instance, the 300 μm SRR (e.g., reference 502b in FIG. 5B) oriented in the H direction is positioned opposite the 300 μm SRR (e.g., reference 502a in FIG. 5B) oriented in the V direction, and so forth. FIG. 6E displays individual plots (labelled as 640) associated with each SRR structure. Each plot 640 represents the transmission spectra corresponding to the orientation of the SRRs concerning the incoming terahertz field polarization, either parallel (H) or perpendicular (V) to the SRR gap.

FIG. 6F illustrates plots 650 of the transmitted intensity terahertz signal captured by a Schottky detector for the SRR structures 502 of the rotating disc 412′ of FIG. 5B. In the plots, the intensity is presented as a function of the incoming terahertz polarization. Notably, a distinct variation in intensity becomes apparent for each SRR structure. This variation distinctly indicates alterations in terahertz polarization. The measurement of transmitted signal intensities from individual SRR structures effectively enables the tracking of changes in terahertz polarization.

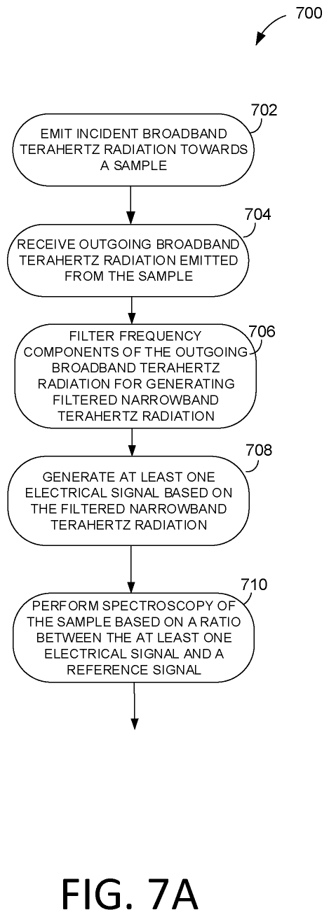

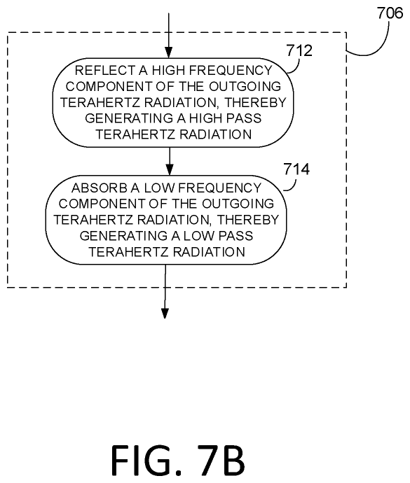

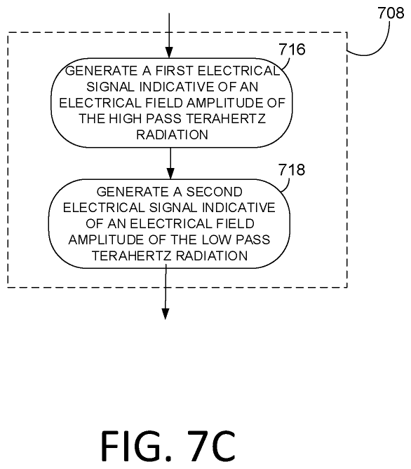

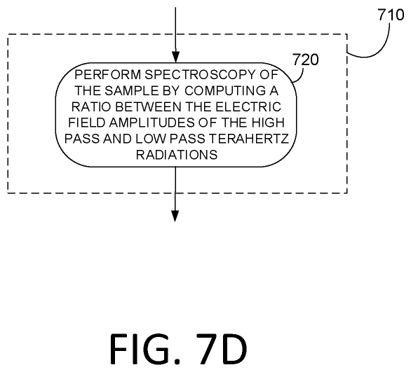

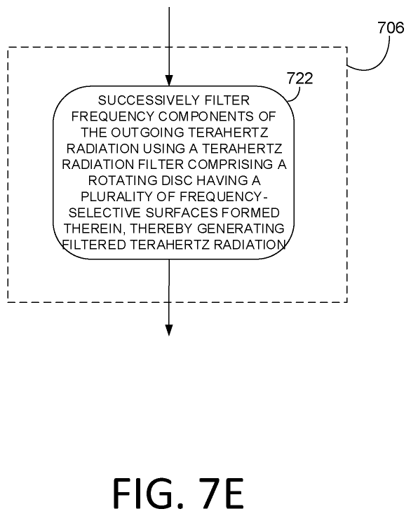

Referring now to FIG. 7A, a method 700 for performing frequency selective terahertz spectroscopy of a sample, for instance using the system 100 of FIG. 1, will now be described. At step 702, incident broadband terahertz radiation is emitted towards a sample. For this purpose, and as described above with reference to FIG. 1, a laser source may first generate a pulse train which is subsequently converted into the incident terahertz radiation by a terahertz radiation emitter. At step 704, outgoing broadband terahertz radiation emitted from the sample is received (at a terahertz radiation filter). Frequency components of the outgoing broadband terahertz radiation are filtered at step 706 for generating filtered narrowband terahertz radiation. At step 708, at least one electrical signal is generated based on the filtered narrowband terahertz radiation. Spectroscopy of the sample is then performed (e.g., at a computing unit) at step 710 based on a ratio between the at least one electrical signal and a reference signal (e.g., using equation (1) above).

Referring now to FIG. 7B, in one embodiment using the system 100 of FIG. 1 having a terahertz radiation filtering unit 111 as illustrated in FIG. 2, step 706 comprises the terahertz radiation filter as in 112 reflecting a high frequency component of the outgoing broadband terahertz radiation (i.e. a component above a cut-off frequency of the terahertz radiation filter 112 of FIG. 2) at step 712, thereby causing the filter to generate a high pass terahertz radiation. In addition, step 706 comprises the terahertz radiation filter 112 absorbing a low frequency component of the outgoing broadband terahertz radiation (i.e. a component below a cut-off frequency of the terahertz radiation filter) at step 714, thereby causing the filter to generate a low pass terahertz radiation.

Referring now to FIG. 7C, in the embodiment using the system 100 of FIG. 1 having a receiving unit 115 as illustrated in FIG. 2, step 708 comprises generating (e.g. by a first terahertz radiation receiver), at step 716, a first electrical signal indicative of an electrical filed amplitude of the high pass terahertz radiation. In addition, in this embodiment, step 708 comprises generating (e.g. by a second terahertz radiation receiver), at step 718, a second electrical signal indicative of an electrical filed amplitude of the low pass terahertz radiation.

Referring now to FIG. 7D, in the embodiment using the system 100 of FIG. 1 having a terahertz radiation filtering unit 111 and a receiving unit 115 as illustrated in FIG. 2, step 710 comprises performing spectroscopy of the sample (e.g., at a computing unit) by computing at step 720 a ratio between the electrical field amplitudes of the high pass and low pass terahertz radiations, using equation (2) above.

Referring now to FIG. 7E, in one embodiment using the system 100 of FIG. 1 having a terahertz radiation filtering unit 111 as illustrated in FIG. 4 (i.e. using a rotating disc 412), the step 706 of filtering frequency components of the outgoing terahertz radiation for generating filtered terahertz radiation comprises, at step 722, successively filtering frequency components of the outgoing terahertz radiation using the terahertz radiation filter 412, thereby causing the filter 412 to generate filtered terahertz radiation. As described herein above with reference to FIG. 4, the terahertz radiation filter 412 may comprise a rotating disc having a plurality of frequency selective surfaces. At least one electrical signal is generated based on the filtered terahertz radiation (step 708 of FIG. 7A) and spectroscopy of the sample is then performed (step 710 of FIG. 7A) based on the ratio between the at least one electrical signal and the reference signal, using equation (1) above and as described herein with reference to FIG. 4.

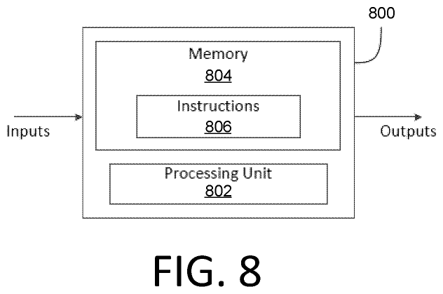

With reference to FIG. 8, part or all of the embodiments of the devices, systems and methods described herein may be implemented in a combination of both hardware and software. FIG. 8 illustrates an example computing device 800 which may be used to implement the system 100 of FIG. 1 and/or the method 700 of FIG. 7A. The computing device 800 comprises a processing unit 802 and a memory 804 which has stored therein computer-executable instructions 806. The processing unit 802 may comprise any suitable devices configured to implement the functionality of the system 100 and/or the method 700 such that instructions 806, when executed by the computing device 800 or other programmable apparatus, may cause the functions/acts/steps performed by the system 100 and/or the method 700 as described herein to be executed. The processing unit 802 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, custom-designed analog and/or digital circuits, or any combination thereof.

The memory 804 may comprise any suitable known or other machine-readable storage medium. The memory 804 may comprise non-transitory computer readable storage medium, for example, but not limited to, an electronic, magnetic, optical, electromagnetic, infrared, or semiconductor system, apparatus, or device, or any suitable combination of the foregoing. The memory 804 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 804 may comprise any storage means (e.g., devices) suitable for retrievably storing machine-readable instructions 806 executable by processing unit 802.

The computing device 800 may be any suitable computing device, such as a desktop computer, a laptop computer, a mainframe, a server, a distributed computing system, a portable computing device, a mobile phone, a tablet, or the like.

In some embodiments, using the systems and methods described herein may allow to simplify the manner in which terahertz spectroscopy is performed. The implementation of a broadband pulsed terahertz emitter with an active frequency selective surface (e.g., a mechanical chopper with some terahertz filters) and an energy or power meter may indeed be sufficient to reveal the spectral signature of the sample in the terahertz frequency range. Ultra-fast qualitative discrimination of materials may then be achieved, which can have an impact on democratizing terahertz technologies for industrial applications. Data that is compatible with the development of a predictive model for targeted applications may be generated.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the systems and methods described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A system for performing frequency selective terahertz spectroscopy of a sample, the system comprising:
a terahertz radiation emitter configured to emit incident broadband terahertz radiation towards the sample;
a terahertz radiation filter configured to receive outgoing broadband terahertz radiation emitted from the sample, the outgoing broadband terahertz radiation indicative of a frequency content of the incident broadband terahertz radiation passing through the sample, and to filter frequency components of the outgoing broadband terahertz radiation for generating filtered narrowband terahertz radiation;
at least one terahertz radiation receiver optically coupled to the terahertz radiation filter, the at least one terahertz radiation receiver configured to receive the filtered narrowband terahertz radiation from the terahertz radiation filter and to generate at least one electrical signal based on the filtered narrowband terahertz radiation; and
a computing unit communicatively coupled to the at least one terahertz radiation receiver and configured to receive therefrom the at least one electrical signal, the computing unit configured to perform spectroscopy of the sample based on a ratio between the at least one electrical signal and a reference signal.

2. The system of claim 1, wherein the terahertz radiation filter is configured to filter the frequency components of the outgoing broadband terahertz radiation by reflecting a high frequency component of the outgoing broadband terahertz radiation that is above a cut-off frequency of the terahertz radiation filter, thereby generating high pass terahertz radiation, and absorbing a low frequency component of the outgoing broadband terahertz radiation that is below the cut-off frequency of the terahertz radiation filter, thereby generating low pass terahertz radiation.

3. The system of claim 2, wherein the at least one terahertz radiation receiver comprises a first terahertz radiation receiver and a second terahertz radiation receiver, the first terahertz radiation receiver configured to receive the high pass terahertz radiation from the terahertz radiation filter and to generate a first electrical signal indicative of an electric field amplitude of the high pass terahertz radiation, and the second terahertz radiation receiver configured to receive the low pass terahertz radiation from the terahertz radiation filter and to generate a second electrical signal indicative of the electric field amplitude of the low pass terahertz radiation.

4. The system of claim 3, wherein the computing unit is communicatively coupled to the first terahertz radiation receiver and to the second terahertz radiation receiver, and configured to receive therefrom the first electrical signal and the second electrical signal, the computing unit configured to perform spectroscopy of the sample based on the ratio between the first electrical signal and the second electrical signal.

5. The system of claim 4, wherein the computing unit is configured to compute the ratio by dividing the electric field amplitude of the high pass terahertz radiation as determined from the first electrical signal and the electric field amplitude of the low pass terahertz radiation as determined from the second electrical signal.

6. The system of claim 1, wherein the terahertz radiation filter comprises a rotating disc having a plurality of frequency selective surfaces formed therein, the plurality of frequency selective surfaces configured to successively filter the frequency components of the outgoing broadband terahertz radiation as the disc rotates for generating the filtered narrowband terahertz radiation.

7. The system of claim 6, wherein the at least one terahertz radiation receiver is configured to generate the at least one electrical signal comprising a plurality of filter signals associated with the frequency components of the outgoing broadband terahertz radiation successively filtered by the plurality of frequency selective surfaces, and further wherein the computing unit is configured to perform spectroscopy of the sample by computing the ratio between an electric field amplitude of each of the plurality of filter signals and the electric field amplitude of the reference signal.

8. The system of claim 6, wherein the plurality of frequency selective surfaces are configured to filter a high frequency component of the outgoing broadband terahertz radiation that is above a cut-off frequency of the terahertz radiation filter, thereby generating high pass terahertz radiation, and to filter a low frequency component of the outgoing broadband terahertz radiation that is below the cut-off frequency of the terahertz radiation filter, thereby generating low pass terahertz radiation.

9. The system of claim 8, wherein the at least one terahertz radiation receiver is configured to generate a first electrical signal indicative of an electric field amplitude of the high pass terahertz radiation, and a second electrical signal indicative of the electric field amplitude of the low pass terahertz radiation, further wherein the computing unit is configured to perform spectroscopy of the sample based on the ratio between the first electrical signal and the second electrical signal, by computing the ratio between an electric field amplitude of the high pass terahertz radiation as determined from the first electrical signal and the electric field amplitude of the low pass terahertz radiation as determined from the second electrical signal.

10. The system of claim 6, wherein the plurality of frequency selective surfaces comprises a first plurality of frequency selective surfaces oriented in a vertical polarization direction and a second plurality of frequency selective surfaces oriented in a horizontal polarization direction, further wherein the at least one terahertz radiation receiver is configured to generate the at least one electrical signal comprising a first electrical signal associated with the frequency components of the outgoing broadband terahertz radiation filtered by each the first plurality of frequency selective surfaces and a second electrical signal associated with the frequency components of the outgoing broadband terahertz radiation filtered by each of the second plurality of frequency selective surfaces, and further wherein the computing unit is configured to perform spectroscopy of the sample based on the ratio between the first electrical signal and the second electrical signal.

11. The system of claim 1, further comprising a laser source configured to generate a train of laser pulses, the terahertz radiation emitter coupled to the laser source and configured to receive the train of laser pulses therefrom and to convert the train of laser pulses into the incident broadband terahertz radiation.

12. The system of claim 11, wherein the terahertz radiation emitter comprises an emitter antenna for receiving the train of laser pulses and a photoconductive switch for emitting the incident broadband terahertz radiation.

13. The system of claim 1, wherein the at least one terahertz radiation receiver comprises a receiver antenna connected to a Schottky diode, the Schottky diode having a usable frequency range that matches a peak power of the filtered narrowband terahertz radiation.

14. A method for performing frequency selective terahertz spectroscopy of a sample, the method comprising:
emitting incident broadband terahertz radiation towards the sample;
receiving outgoing broadband terahertz radiation emitted from the sample, the outgoing broadband terahertz radiation indicative of a frequency content of the incident broadband terahertz radiation passing through the sample;
filtering frequency components of the outgoing broadband terahertz radiation for generating filtered narrowband terahertz radiation;
generating at least one electrical signal based on the filtered narrowband terahertz radiation; and
performing spectroscopy of the sample based on a ratio between the at least one electrical signal and a reference signal.

15. The method of claim 14, wherein filtering the frequency components of the outgoing broadband terahertz radiation comprises reflecting a high frequency component of the outgoing broadband terahertz radiation that is above a cut-off frequency of the terahertz radiation filter, thereby generating high pass terahertz radiation, and absorbing a low frequency component of the outgoing broadband terahertz radiation that is below the cut-off frequency of the terahertz radiation filter, thereby generating low pass terahertz radiation.

16. The method of claim 15, wherein generating the at least one electrical signal comprises generating a first electrical signal indicative of an electric field amplitude of the high pass terahertz radiation and a second electrical signal indicative of the electric field amplitude of the low pass terahertz radiation, further wherein spectroscopy of the sample is performed based on the ratio by dividing the electric field amplitude of the high pass terahertz radiation as determined from the first electrical signal and the electric field amplitude of the low pass terahertz radiation as determined from the second electrical signal.

17. The method of claim 14, wherein the frequency components of the outgoing broadband terahertz radiation are successively filtered by a plurality of frequency selective surfaces formed in a rotating disc, further wherein generating the at least one electrical signal comprises generating a plurality of filter signals associated with the frequency components of the outgoing broadband terahertz radiation successively filtered by the plurality of frequency selective surfaces, and further wherein spectroscopy of the sample is performed by computing the ratio between an electric field amplitude of each of the plurality of filter signals and the electric field amplitude of the reference signal.

18. The method of claim 14, wherein the frequency components of the outgoing broadband terahertz radiation are successively filtered by a first plurality and a second plurality of frequency selective surfaces formed in a rotating disc, the first plurality of frequency selective surfaces oriented in a vertical polarization direction and the second plurality of frequency selective surfaces oriented in a horizontal polarization direction, further wherein generating the at least one electrical signal comprises generating a first electrical signal associated with the frequency components of the outgoing broadband terahertz radiation filtered by each the first plurality of frequency selective surfaces and a generating second electrical signal associated with the frequency components of the outgoing broadband terahertz radiation filtered by each of the second plurality of frequency selective surfaces, and further wherein spectroscopy of the sample is performed based on the ratio between the first electrical signal and the second electrical signal.

19. A terahertz radiation filter for use in performing frequency selective terahertz spectroscopy of a sample, comprising:
a rotating disc; and
a plurality of frequency selective surfaces radially formed in the rotating disc, the plurality of frequency selective surfaces configured to successively filter, as the disc rotates, frequency components of broadband terahertz radiation incident on the rotating disc and to generate filtered narrowband terahertz radiation based on the broadband terahertz radiation.

20. The terahertz radiation filter of claim 19, wherein the plurality of frequency selective surfaces comprises a first plurality of frequency selective surfaces oriented in a vertical polarization direction and a second plurality of frequency selective surfaces oriented in a horizontal polarization direction.
